(19) United States
(12) Patent Application Publication
(10) Pub. No.: US 2026/0080057 A1
(43) Pub. Date: Mar. 19, 2026

(54) GENERATIVE ARTIFICIAL INTELLIGENCE INFORMATION SECURITY MANAGEMENT SYSTEM AND METHOD

(71) Applicants: Inventec (Pudong) Technology Corporation, Shanghai (CN); INVENTEC CORPORATION, TAIPEI CITY (TW)

(72) Inventors: Wei-Chao CHEN, TAIPEI CITY (TW); Ming-Chi CHANG, TAIPEI CITY (TW); Chuo-Jui WU, TAIPEI CITY (TW)

(21) Appl. No.: 19/237,026

(22) Filed: Jun. 13, 2025

(30) Foreign Application Priority Data
Sep. 19, 2024 (CN) 202411310888.9

(51) Int. Cl. G06F 21/56; G06F 21/54

(52) U.S. Cl. CPC G06F 21/56; G06F 21/54

(57) ABSTRACT

A generative artificial intelligence (AI) information security management method, comprising following steps: receiving a question to a local generative AI model; providing a security risk analysis information of the question, wherein the security risk analysis information includes a Boolean value of an information security concern; providing a response to the question through the local generative AI model; after the local generative AI model provides the response to the question, in response to receiving a request for answering with an external generative AI model, determining whether the Boolean value of the information security concern is true; and in response to the Boolean value of the information security concern being true, providing a message that the question has the information security concern.

### RELATED APPLICATIONS

This application claims priority to China Application Serial Number 202411310888.9, field Sep. 19, 2024, which is herein incorporated by reference.

### BACKGROUND

### Technical Field

The present disclosure relates to a computer system and an operating method thereof, and more particularly to a generative artificial intelligence (AI) information security management system and method.

### Description of Related Art

The use of generative AI is becoming more widespread, and it is also recognized by many technology organizations as the next AI technology that will bring disruptive innovation. In Gartner Consulting Company's (Gartner) report, Top 10 Strategic Technology Trend for 2024, it is mentioned that by 2025, more than 80% of enterprises will have deployed or introduced generative AI technology. By 2023, this proportion was less than 5%.

However, Gartner also mentioned the cybersecurity issues of generative AI model in the Top Trends in Cybersecurity for 2024, and reminded relevant information security units to start preparing for the transformation impact and information security risks brought by generative AI model.

Currently, many application services based on generative AI model are cloud services. Therefore, the use of cloud generative AI model for downstream digital application development will inevitably require the act of uploading data. Therefore, enterprises will face higher information security risks.

To leverage generative AI model for digital transformation and avoid the risk of data leakage at the same time, some enterprises use large language models (LLM) that can be downloaded to the local environment as models to drive generative AI model. However, generative AI model based on local LLM has the following disadvantages: a risk of obtaining incorrect responses when asking about rapidly developing subjects; and the immense cost of model updates leading to greater losses for companies after introducing.

Therefore, if the digital applications that a company needs to rely on generative AI model are applications that require model updates, it is very impractical to introduce local generative AI model. Because “a generative AI that cannot give the correct answer is of no value to use, even if there is no security risk.” Unless the company is willing to bear the immense cost of training or updating the model.

Going back to what was mentioned in Gartner's report at the beginning, if companies want to be competitive among their peers, it is an inevitable trend to rely on cloud generative AI services. Therefore, how to reduce or even avoid the information security risks caused by cloud generative AI services is an issue that companies urgently need to address.

### SUMMARY

The disclosure provides a generative AI information security management system and method to solve the problems of the prior art.

One aspect of the present disclosure directs to a generative artificial intelligence (AI) information security management method, comprising following steps: receiving a question to a local generative AI model; providing a security risk analysis information of the question, wherein the security risk analysis information includes a Boolean value of an information security concern; providing a response to the question through the local generative AI model; after the local generative AI model provides the response to the question, in response to receiving a request for answering with an external generative AI model, determining whether the Boolean value of the information security concern is true; and in response to the Boolean value of the information security concern being true, providing a message that the question has the information security concern.

In some embodiments in the disclosure, the generative AI information security management method further includes: in response to the Boolean value of the information security concern being false, providing another response to the question through a cloud generative AI model.

In some embodiments in the disclosure, the generative AI information security management method is further includes: setting an information security risk determination threshold; obtaining data leakage assessment values assessed by security guard algorithms for the question; and in response to one of the data leakage assessment values assessed for the question by any one of the security guard algorithms being higher than the information security risk determination threshold, determining the Boolean value of the information security concern is true.

In some embodiments in the disclosure, the generative AI information security management method is further includes: in response to each of the data leakage assessment values assessed for the question by the security guard algorithms being lower than or equal to the information security risk determination threshold, determining the Boolean value of the information security concern is false.

In some embodiments in the disclosure, operations of one of the security guard algorithms includes: establishing an information security dictionary that records an information security score of each word as an assessment standard; and calculating a quantitative information security score corresponding to the question as the data leakage assessment value based on the information security dictionary.

In some embodiments in the disclosure, operations of one of the security guard algorithms includes: based on a database, searching for a correlation between the question and a content of the database, and obtaining the data leakage assessment value based on the correlation between the question and the content of the database.

In some embodiments in the disclosure, operations of one of the security guard algorithms includes: quantifying the data leakage assessment value for the question through a local large language model.

In some embodiments in the disclosure, the generative AI information security management method is further includes: classifying with user accounts and serial numbers; performing an OR aggregation on the Boolean values of the information security concern classified; collecting a question time and a question asked corresponding to each of the serial numbers; classifying again with the user accounts, and calculating data percentage values where the Boolean value is true; and collecting the Boolean values and the data percentage values as a basis for tracking behaviors of the user accounts.

One aspect of the present disclosure directs to a generative AI information security management system. The generative AI information security management system includes a storage device, a transmission device, and a processor. The storage device is used for storing a local generative AI model. The transmission device is used for receiving a question to the local generative AI model. The processor is electrically connected to the storage device and the transmission device and used for providing a security risk analysis information of the question, wherein the security risk analysis information includes a Boolean value of an information security concern; providing a response to the question through the local generative AI model; after the local generative AI model provides the response to the question, in response to receiving a request for answering with an external generative AI model, determining whether the Boolean value of the information security concern is true; and in response to the Boolean value of the information security concern being true, providing a message that the question has the information security concern.

In some embodiments in the disclosure, in response to the Boolean value of the information security concern being false, the processor is further used for providing another response to the question through a cloud generative AI model.

In summary, the technical solution of the present discloser has obvious advantages and beneficial effects compared with the prior art. Through the generative AI information security management system and the generative AI information security management method of the present disclosure, any question to be asked to the cloud generative AI model will first necessarily be determined locally having no risk of data leakage before released. In addition, in order to strengthen the information security architecture, the generative AI information security management system and the generative AI information security management method of the present disclosure will record all question information asked to the generative AI model simultaneously to track and determine the possible sources of information security leaks, so that the local information security has a second layer of safety net, thereby achieving the goal of perfect zero information security risk.

The above description will be described in detail below with embodiments, and a further explanation will be provided for the technical solution of the present disclosure.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIGS. 1 to 3 are flowcharts of generative artificial intelligence information security management methods in accordance with some embodiments of the present disclosure.

FIG. 4 is a trajectory diagram of information security risk behaviors in accordance with some embodiments of the present disclosure.

FIG. 5 is a deviation diagram of security guard algorithms in accordance with some embodiments of the present disclosure.

FIG. 6 is a schematic block diagram of a generative artificial intelligence information security management system in accordance with some embodiments of the present disclosure.

### DETAILED DESCRIPTION

To make the description of the present disclosure more detailed and complete, reference may be made to the attached drawings and various embodiments described below, in which the same numbers represent the same or similar elements. On the other hand, well-known elements and steps are not described in the embodiments to avoid unnecessary limitation of the present disclosure.

The purpose of the disclosure is to establish a generative AI information security risk control system (hereinafter referred to as “this system”) that may perform on any question content asked to generative AI model. Through this system, any question to be asked to the cloud generative AI model must first be determined by the company's local end to be no risk of data leakage before released. In addition, to strengthen the company's information security architecture, this system will also record all the question information asked to the generative AI model to track and determine the possible sources of information security leaks, so that the company's information security has a second layer of safety net, thereby achieving the goal of perfect zero information security risk.

For example, a user logs into a user account and asked an addition question “Calculate 1+3+5+7+9”. Because there was no information security concern, the system correctly responded with 25. As another example, a user logs into a user account, provides information related to company data, and requests to calculate the total number of factories in the company. Because the system determines that the question includes company's confidential information, the system will respond to the user account with a message that the question has the information security concern.

In summary, this system has the following functions: 1. Automatically determining whether the questions asked to the generative AI model have the risk of confidential information leakage; 2. Having an optimized system program that may ensure that the information security risk of the company's cloud generative AI model will become lower; 3. Automatically recording the questions asked, and analyzes and traces the possible sources of information security leakage; 4. Integrating local and cloud generative AI services, and optionally, not having the urgent cost burden of updating the local LLM.

Therefore, this system may bring the following benefits to companies when they use generative AI model for digital transformation or promotion of digital applications: 1. Having a mechanism that does not require updating models and automatically determines information security risks, so as to free companies from the concerns of high maintenance costs, and allow companies to develop and promote generative AI application services without concerns; 2. Ensuring that application services under generative AI model may receive the latest or newest responses, to protect the developed digital applications from the risk of failure due to the generative AI model not being updated; 3. Automatically tracking the records of user questions asked to the generative AI model, and building a second layer of security barrier for the company's information security risks; 4. Ensuring that the company's information security risks will be reduced after optimizing the system, so as to achieve the company's expectation of perfect zero information security risks.

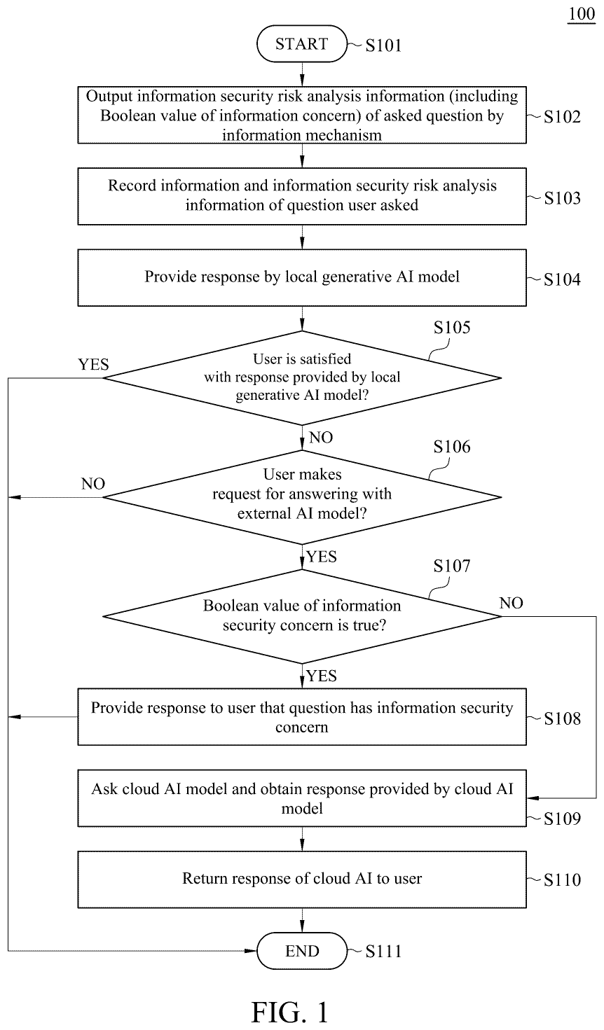

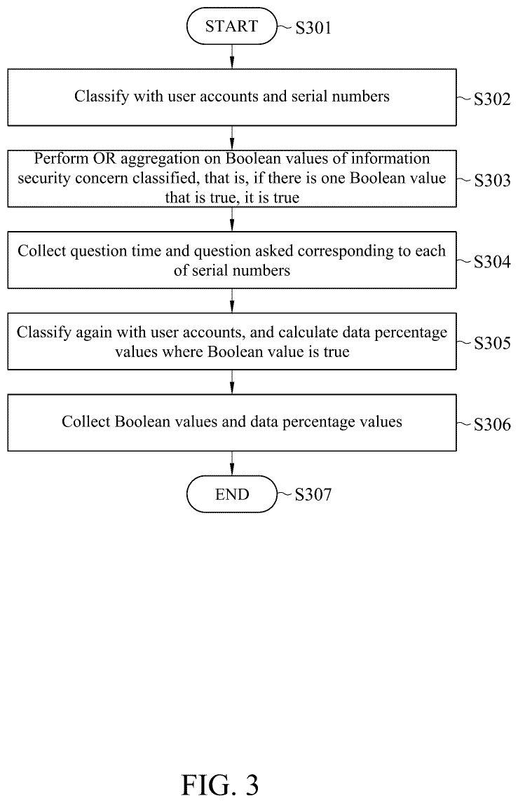

To further explain the operation method of the above system, please refer to FIGS. 1 to 3 at the same time. FIGS. 1 to 3 are flowcharts of generative AI information security management methods 100, 200, 300 in accordance with some embodiments of the present disclosure. The generative AI information security management method 100 represents the main framework of integrating local and cloud generative AI model, the generative AI information security management method 200 determines the information security mechanism of the question with the information security concerns, and the generative AI information security management method 300 represents the data leakage source tracking and analysis module. The steps mentioned in this embodiment should be understood that except for those whose order is specifically described, may be adjusted in order according to actual needs, and may even be executed simultaneously or partially simultaneously.

The generative AI information security management methods 100, 200, 300 may be in the form of a computer program product on a non-transitory computer readable medium, wherein the computer readable medium has computer readable instructions included in the medium. Suitable medium may include any of the following: non-volatile memory, such as read-only memory (ROM), programmable read-only memory (PROM), erasable programmable read-only memory (EPROM), electronically erasable programmable read-only memory (EEPROM); volatile memory, such as static random access memory (SRAM), dynamic random access memory (SRAM), double data rate random access memory (DDR-RAM); optical storage devices, such as compact disc read-only memory (CD-ROM), digital versatile disc read-only memory (DVD-ROM); magnetic storage devices, such as hard disk drives and floppy disk drives.

This system is a system that integrates local and cloud generative AI model, and the local generative AI model is a system that locally uses a LLM not need to be updated. The main framework process of this system is shown in FIG. 1.

In Step S101, a user logs into the system with a user account and asks a question to the local generative AI model of the system. The system receives the question asked to the local generative AI model. In Step S102, information security risk analysis information of the question is provided, and the information security risk analysis information includes a Boolean value of an information security concern. In Step S103, information of the question asked by the user account and information security risk analysis information thereof are recorded. In Step S104, a response to the question is provided through the local generative AI model. In Step S105, it is determined whether the user is satisfied with the response provided by the local generated AI. For example, if the user account selects the satisfied option provided in the system, it is determined that the user is satisfied with the response provided by local generated AI, and Step S111 is performed. On the contrary, if the user account selects the dissatisfied option provided in the system, it is determined that the user is dissatisfied with the response provided by local generated AI, and Step S106 is performed to determine whether the user has made a request for answering with an external generative AI model.

After the local generative AI model provides the above response to the question, when a request for answering with external generative AI model is received, in Step S107, it is determined whether the Boolean value of the information security concern is true. When the Boolean value of the information security concern is true, in Step S108, message that the question has the information security concern is provided, and Step S111 is performed.

On the contrary, when the Boolean value of the information security concern is false, in Step S109, another response to the question is provided through the cloud generative AI model. In Step S110, the cloud generative AI model mentioned above is returned to provide another response to the question to the user account.

It may be understood from the main framework process of this system that this system has the following characteristics: 1. Any question will first be asked to the local generative AI model. If the answer of the local generative AI model is sufficient to satisfy the user, the cloud generative AI model will not be sought. Therefore, there are no concerns about data leakage. In addition, even if the questions asked include confidential information, it will not prohibit the local generative AI model from responding, maintaining the user's right to have the greatest response. 2. Only questions that are analyzed without security concerns will be released to the cloud generative AI model. When the user is not satisfied with the response of the local generative AI model and makes a request for answering with an external generative AI (Step S106), the system will decide whether to release the question based on whether it has security concerns (Step S102); 3. Any question will be performed the information security risk analysis (Step S102) and be recorded (Step S103). As any question is not uploaded to the cloud, it may be free from the risk of data leakage. However, the user's behavior of asking questions is the source of the most upstream information security risk. This system analyzes all questions of all users to determine whether they have information security risks and records them. This record will become an important basis for the company's next step of information security control over “people”, thereby strengthening the company's overall information security.

It may be understood that the main framework of this system has the functions of both generative AI model and human control: 1. To control the generative AI model, it is necessary to first ask the local generative AI model. If the local generative AI model is unable to answer the user's question, the analysis result of the information security mechanism will further used for deciding whether to ask the cloud generative AI model; 2. For human control, the information security mechanism will perform information security risk analysis on all questions asked by everyone and record them at the same time. Therefore, this system may perform (including but not limited to) statistical or behavioral analysis on each person based on the information security risk analysis information and classify users with high information security risks and control them.

Whether in cloud generative AI models or human control, the information security mechanism in the main framework of this system plays the most important role. The following will describe the operations of the information security mechanism of this system.

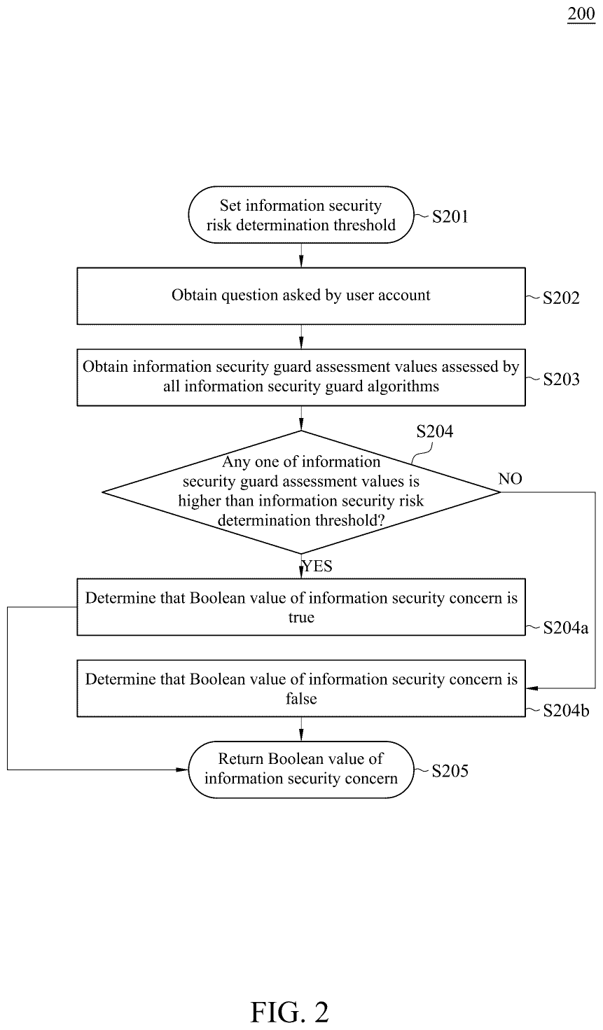

The generative AI information security management method 200 determines the information security mechanism of the question with the information security concerns. The information security mechanism of this system is formulated based on the determination results of different information security guard algorithms. Each information security guard algorithm quantifies the question asked into a number between 0 and 1, where 1 represents the most serious data leakage and 0 represents no risk of data leakage. Once the security guard has made a determination, the security mechanism of this system may give a Boolean value of the information security concern for the question asked according to the process in FIG. 2 below (true: there is a data leakage concern; false: there is no data leakage concern).

In Step S201, the information security risk determination threshold is set. In Step S202, the question asked by the user account is obtained. In Step S203, data leakage assessment values assessed by the information security guard algorithms for the question mentioned above are obtained. In Step S204, it is determined whether the data leakage assessment value of any of the information security guard algorithms for the question is higher than the information security risk determination threshold. When the data leakage assessment value of any of the information security guard algorithms for the question is higher than the information security risk determination threshold, in Step S204a, the Boolean value of the information security concern is determined to be true. On the contrary, when the data leakage assessment value of any of the information security guard algorithms for the question is lower than or equal to the information security risk determination threshold, in Step S204b, the Boolean value of the information security concern is determined to be false. In Step S205, the Boolean value of the information security concern is returned.

In the information security mechanism of this system, as long as one of the values assessed by the information security guard algorithms is higher than the set information security risk determination threshold, the information security mechanism will consider that the question asked by the user has the information security concern. Therefore, the information security mechanism of this system has the following characteristics: 1. A process or method to evaluate the information security guard algorithms is unnecessary for the information security mechanism of this system; 2. This system may achieve stricter information security control and reduce the risk of data leakage merely by increasing the number of information security guards; 3. This system may avoid the possibility of information security mechanism failure due to too many information security guards by loosening the information security risk determination threshold, that is, to avoid “all questions will be determined as having information security concerns and cannot be asking to the cloud generative AI model.”

In some embodiments of the present discloser, the operation of one of the information security guard algorithms mentioned above includes: establishing an information security dictionary, which records an information security score of each word as an assessment standard; and based on the information security dictionary, calculating a quantitative information security score corresponding to the question as the data leakage assessment value.

For example, there are three different words in the question asked by the user account, and the corresponding scores in the information security dictionary are 0.7, 0.3 and 0.8. The information security guard algorithm may take the average, maximum or other methods of the scores 0.7, 0.3 and 0.8 to quantify the information security score.

In addition, when obtaining the score of the information security dictionary, the text comparison is not restricted to exact equivalence, and it may be determined by fuzzy comparison. For example, letters with different capitalization may be considered the same word, and the Chinese and English names or abbreviations of synonyms may be considered the same name. There are many packages or models that may perform fuzzy comparison, such as NLTK package in Python, or through LLM with appropriate prompts.

In some embodiments of the present disclosure, the operations of one of the information security guard algorithms includes: based on the data center (database), searching for the correlation between the question and the content of the database, and obtaining a data leakage assessment value based on the correlation between the question and the content of the database.

For example, the data center has data forms related to orders and shipments, and records information related to manufacturers, products, and shipment volumes. A feasible determination method is as follows: a. Check whether the question includes words related to the name of the data forms, such as orders. Therefore, the orders and the shipping data forms may first be filtered out (for example, the fuzzy comparison mentioned above may be used to search for the data form name); b. Extract the unique value of each field in the form (such as manufacturer and product), and use the fuzzy comparison to confirm how many words in the question are included in the unique value of each field; c. Quantify the assessment value based on the words determined in b. For example, if it is higher than a certain number (for example, more than 3 words), it returns 1, otherwise it returns 0; and for example, it returns the percentage of words in the entire sentence.

In some embodiments of the present disclosure, the operations of one of the information security guard algorithms includes: quantifying the data leakage assessment value for the question through a local LLM.

For example, a document is provided with confidential data such as a series of confidential words, or a unique value of each data form in the data center, to the local LLM, and after asking the local LLM that whether the user's question includes too many words of the confidential data in the document, the response of the local LLM is quantified. For example, retrieval augmented generation (RAG) is a technique that provides the LLM for performing the technique mentioned above.

It should be understood that the information security guard algorithms that may be used in this system are not limited to the examples above. Any algorithm or related variations that may quantify the questions asked by users into numbers between 0 and 1, with 1 representing the most serious data leakage and 0 representing no risk of data leakage, may be added to the information security guard algorithms in the information security mechanism of this system.

The generative AI information security management method 300 represents the data leakage source tracking and analysis module. In Step S102 of the main framework of integrating local and cloud generative AI model in FIG. 1, the information security mechanism within the system will perform the information security risk analysis on the questions asked by the users, in which the information obtained will at least include the name of each information security guard algorithm and the corresponding information security guard assessment value (that is, the data leakage assessment value assessed by the information security guard algorithm for the question). Thereafter, after the information security mechanism for determining the information security concern in FIG. 2 is performed, the information security risk determination threshold and the Boolean value of the information security concern may be output.

For example, the system may have a built-in “information security risk assessment table” to implement the action of Step S103 of the main framework of integrating local and cloud generative AI model in FIG. 1. The information security risk assessment table records the user's question information to the generative AI model of the system in Step S101, and the name of each information security guard algorithm, the corresponding information security guard assessment value, the information security risk determination threshold and the Boolean value of the information security concern generated in Step S102.

For example, the column information of the information security risk assessment table is as follows: 1. Serial Number: recording ID accounts for distinguishing questions, automatically generated by the system (the data with the same serial number represents the information of the same question); 2. User Account (name): recording the unique account (name) that may be used for identifying the user; 3. Time: recording the time when the user asks the question; 4. Question: recording the content of the question asked by the user; 5. Guard Account (name): recording the account of the information security guard algorithm; 6. Information Security Assessment Value: recording the information security assessment value of the information security guard algorithm (such as: the data leakage assessment value assessed by the information security guard algorithm for the question); 7. Information Security Threshold: recording the information security risk determination threshold used; 8. Boolean Value of Information Security Concern: true: representing that the information security assessment value is higher than the information security threshold; false: representing that the information security assessment value is not higher than the information security threshold.

Based on the information security risk assessment table of this system, this system may perform a lot of data leakage analysis on the user's behavior. For example, filter the user accounts with high information security risk behaviors and track the behaviors of the user accounts.

In Step S301, the data leakage source tracking and analysis module is started. In Step S302, classification is performed with the user accounts and the serial numbers. In Step S303, the Boolean values of the information security concern classified are OR aggregated, that is, if there is one Boolean value that is true, it is true. In Step S304, the question time and question asked corresponding to each of the serial numbers are collected. In Step S305, they are classified again with the user accounts and the data percentage values of where the Boolean value is true are calculated. In Step S306, the Boolean values and the data percentage values are collected as a basis for tracking the behaviors of the user accounts. In Step S307, the data leakage source tracking and analysis module is terminated.

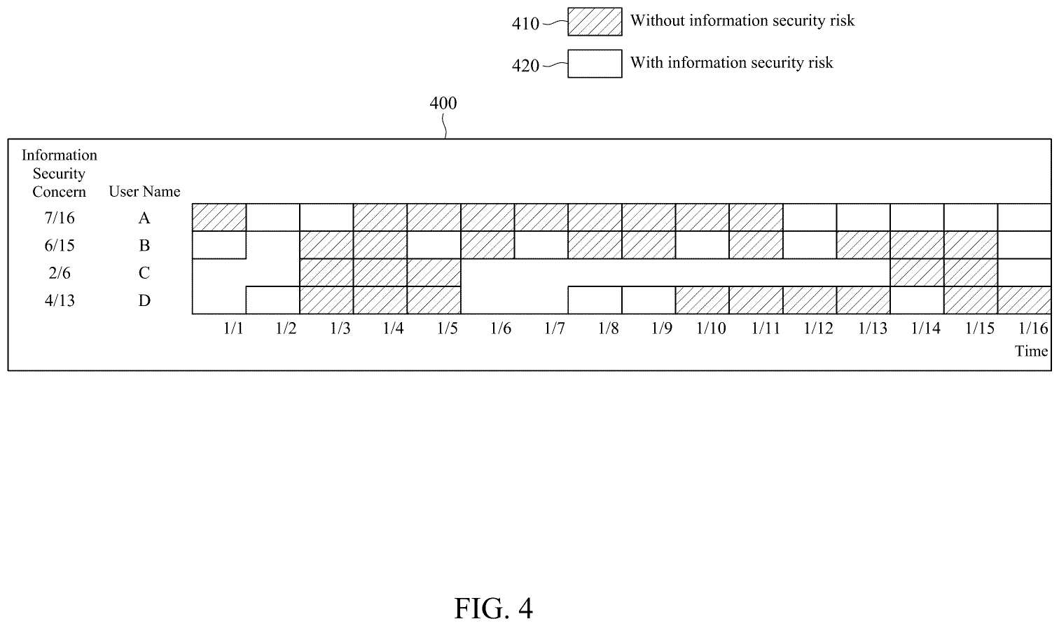

The system sorts the users from high to low according to the data percentage values calculated in Step S305, and the users with higher rankings are the users identified by the system as having potential high information security risk behaviors. In addition, with the question time information collected in Step S304, the system may further create a “trajectory diagram 400 of information security risk behaviors” to track and analyze the behavior of users with high information security risk behaviors, as shown in FIG. 4. The trajectory diagram 400 of the information security risk behaviors in FIG. 4 shows that the questions of the user names A, B, C, and D on different dates are without information security risk 410 or with information security risk 420.

For example, the information security risk determination threshold is set to 0.4. In the trajectory diagram 400 of the information security risk behaviors, the users are sorted according to the value of “information security concern”, where the value of information security concern is the proportion of users'questions with information security concerns (for example, with information security risk 420) relative to the total number of questions asked. In FIG. 4, the system considers that the user corresponding to the user name A has the highest potential information security risk behavior. The time when each user asks a question will be recorded to identify possible reasons for information security risk behaviors. For example, the questions assessed having information security risks of the user name A are mostly concentrated after January 12th, which may be due to a new digital application being developed after January 12th and all the topics asked during the testing process having high information security risks; the questions assessed having information security risks of the user name B are more evenly dispersed, reflecting that the information security risk questioning behavior may be regularly scheduled by a currently developed digital application that regularly schedules questions related to a high information security risk question. All questions asked may be found in the diagram. Therefore, person maintaining information security may further determine the causes of users' information security risk behaviors.

On the other hand, the system uses the information in the information security risk assessment table to generate a “deviation diagram 500 of the information security guard algorithm” to analyze whether the information security guard algorithms have deviation.

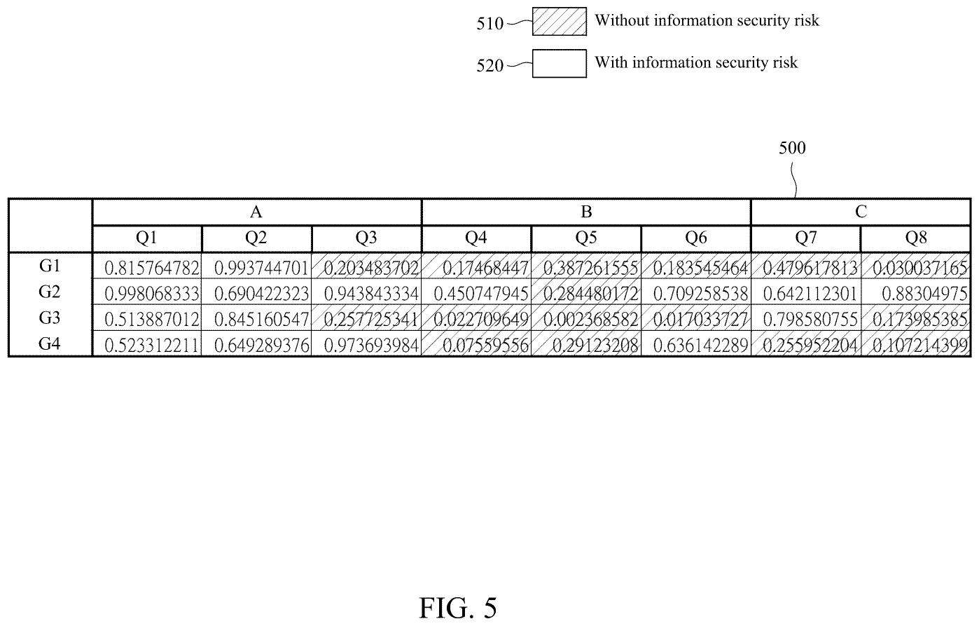

The questions are sorted with users and question time by the system. Afterwards, the assessment result of each information security guard algorithm for each question is plotted into the deviation diagram 500 of the security guard algorithms, as shown in FIG. 5. The deviation diagram 500 of the information security guard algorithm in FIG. 5 shows that the information security guard algorithms G1, G2, G3, G4 assess that each of different questions Q1, Q2, Q3, Q4, Q5, Q6, Q7, Q8 of the user names A, B, C, D is without the information security risk 510 or with the information security risk 520.

Through the deviation diagram 500 of the information security guard algorithms in FIG. 5, it may be observed whether the information security guard algorithm has a bias. For the information security guard algorithm G2 in FIG. 5, its determination results tend to be stricter than those of other information security guards (only one question, Q5, has no information security risk concerns). Therefore, the information security guard algorithm G2 may be a biased guard algorithm and needs to be re-optimized or adjusted. Otherwise, the information security mechanism of this system may become ineffective due to the existence of the information security guard algorithm G2.

In addition, through the deviation diagram 500 of the information security guard algorithms in FIG. 5, it may be observed whether the user needs information security education. In FIG. 5, most security guards considered that the questions asked by user name A have information security concerns, therefore, the company is very likely to incur information security risks due to the behavior of the user name A (especially compared to the user name B), so it may be necessary to arrange information security education for the user corresponding to the user name A.

It should be understood that the above two analysis scenarios are only one of the analysis scenarios applicable to the information security risk assessment table of this system. There are many extended analysis scenarios that may be analyzed with the information security risk assessment table of this system, and it is not limited to the two scenarios listed above.

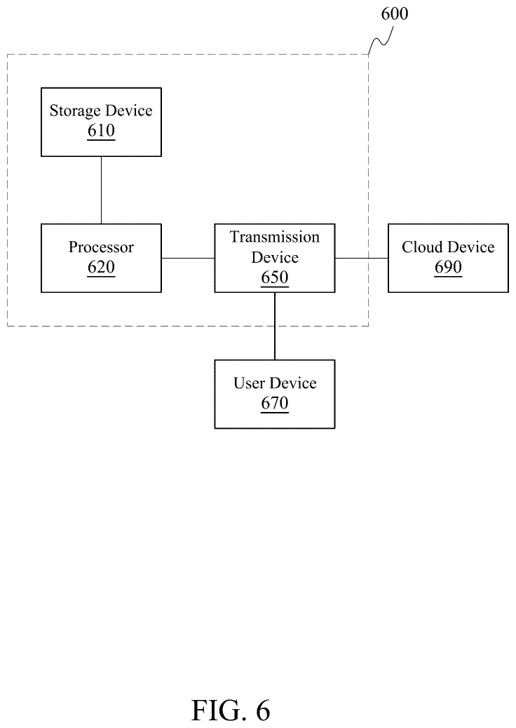

FIG. 6 is a schematic block diagram of a generative AI information security management system 600 in accordance with some embodiments of the present disclosure. The generative AI information security management system 600 may run the generative AI information security management methods 100, 200, and 300 described above.

As shown in FIG. 6, the generative AI information security management system 600 includes a storage device 610, a processor 620 and a transmission device 650. For example, the storage device 610 may be a hard disk, a flash memory or other storage media, the processor 620 may be a central processor, a controller or other circuits, and the transmission device 650 may be a transmission interface, a transmission line, a network device, a communication device or other transmission media.

In terms of architecture, the storage device 610 is electrically connected to the processor 620, and the processor 620 is electrically connected to the transmission device 650. Data may be transmitted between the transmission device 650 and the cloud device 690, and data may be transmitted between the transmission device 650 and the user device 670.

In practice, for example, the cloud device 690 may be a cloud server, and the cloud device 690 has the cloud generative AI model mentioned above. The user device 670 may be a computer, a mobile phone, etc. The user may log into the generative AI information security management system 600 with a user account (name) to ask questions.

In some embodiments of the present disclosure, the storage device 610 stores the local generative AI model, the user device 670 transmits questions to the transmission device 650, and the transmission device 650 receives questions for the local generative AI model. The processor 620 provides the information security risk analysis information of the questions, which includes the Boolean value of the information security concern. The processor 620 provides a response to the question through the local generative AI model, and the transmission device 650 returns the response to the question provided by the local generative AI model to the user device 670. After the local generative AI model provides the response to the question, when the transmission device 650 receives a request for answering with external generative AI model, the processor 620 determines whether the Boolean value of the information security concern is true. When the Boolean value of the information security concern is true, the processor 620 provides a message that the question has an information security concern. The transmission device 650 returns a message that the question has an information security concern to the user device 670.

In some embodiments of the present invention, when the Boolean value of the information security concern is false, the processor 620 obtains another response to the question mentioned above through the cloud generative AI model of the cloud device 690 via the transmission device 650. The processor 620 returns another response of the cloud generative AI model to the user device 670 via the transmission device 650.

In summary, the technical solution of the present disclosure has obvious advantages and beneficial effects compared with the prior art. Through the generative AI information security management system 600 and the generative AI information security management methods 100, 200, 300 of the present disclosure, any question to be asked to the cloud generative AI model must first be determined locally to have no risk of data leakage before released. In addition, to strengthen the information security architecture, the generative AI information security management system 600 and the generative AI information security management methods 100, 200, and 300 of the present disclosure will simultaneously record all question information asked to the generative AI model in order to track and determine possible sources of information security leaks, so that the local information security has a second layer of safety net, thereby achieving the goal of perfect zero information security risk.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A generative artificial intelligence (AI) information security management method, comprising following steps:
receiving a question to a local generative AI model;
providing a security risk analysis information of the question, wherein the security risk analysis information comprises a Boolean value of an information security concern;
providing a response to the question through the local generative AI model;
after the local generative AI model provides the response to the question, in response to receiving a request for answering with an external generative AI model, determining whether the Boolean value of the information security concern is true; and
in response to the Boolean value of the information security concern being true, providing a message that the question has the information security concern.

2. The generative AI information security management method of claim 1, further comprising:
in response to the Boolean value of the information security concern being false, providing another response to the question through a cloud generative AI model.

3. The generative AI information security management method of claim 1, further comprising:
setting an information security risk determination threshold;
obtaining data leakage assessment values assessed by security guard algorithms for the question; and
in response to one of the data leakage assessment values assessed for the question by any one of the security guard algorithms being higher than the information security risk determination threshold, determining the Boolean value of the information security concern is true.

4. The generative AI information security management method of claim 3, further comprising:
in response to each of the data leakage assessment values assessed for the question by the security guard algorithms being lower than or equal to the information security risk determination threshold, determining the Boolean value of the information security concern is false.

5. The generative AI information security management method of claim 3, wherein operations of one of the security guard algorithms comprises:
establishing an information security dictionary that records an information security score of each word as an assessment standard; and
calculating a quantitative information security score corresponding to the question as the data leakage assessment value based on the information security dictionary.

6. The generative AI information security management method of claim 3, wherein operations of one of the security guard algorithms comprises:
based on a database, searching for a correlation between the question and a content of the database, and obtaining the data leakage assessment value based on the correlation between the question and the content of the database.

7. The generative AI information security management method of claim 3, wherein operations of one of the security guard algorithms comprises:
quantifying the data leakage assessment value for the question through a local large language model.

8. The generative AI information security management method of claim 1, further comprising:
classifying with user accounts and serial numbers;
performing an OR aggregation on the Boolean values of the information security concern classified;
collecting a question time and a question asked corresponding to each of the serial numbers;
classifying again with the user accounts, and calculating data percentage values where the Boolean value is true; and
collecting the Boolean values and the data percentage values as a basis for tracking behaviors of the user accounts.

9. A generative AI information security management system, comprising:
a storage device, used for storing a local generative AI model;
a transmission device, used for receiving a question to the local generative AI model; and
a processor, electrically connected to the storage device and the transmission device, wherein the processor is used for providing a security risk analysis information of the question, wherein the security risk analysis information comprises a Boolean value of an information security concern; providing a response to the question through the local generative AI model; after the local generative AI model provides the response to the question, in response to receiving a request for answering with an external generative AI model, determining whether the Boolean value of the information security concern is true; and in response to the Boolean value of the information security concern being true, providing a message that the question has the information security concern.

10. The generative AI information security management system of claim 9, wherein in response to the Boolean value of the information security concern being false, the processor is further used for providing another response to the question through a cloud generative AI model.
